(19) United States
(12) Patent Application Publication
(10) Pub. No.: US 2019/0076947 A1
(43) Pub. Date: Mar. 14, 2019

(54) DISSIMILAR METAL MEMBER AND MANUFACTURING METHOD THEREOF

(71) Applicant: Samsung Electronics Co., Ltd., Gyeonggi-do (KR)

(72) Inventors: Young-Jong SHIN, Busan (KR); Jin-Hyeong PARK, Gyeongsangbuk-do (KR)

(21) Appl. No.: 16/123,334

(22) Filed: Sep. 6, 2018

(30) Foreign Application Priority Data
Sep. 13, 2017 (KR) 10-2017-0117445

(51) Int. Cl. B23H 5/04; B23K 26/359; B23K 26/323; B22D 17/22

(52) U.S. Cl. CPC B23H 5/04; B23K 26/359; B23K 2103/10; B22D 17/2245; G06F 2200/1633; B23K 26/323

(57) ABSTRACT

According to various embodiments, a dissimilar metal member according to various embodiments, comprises a first metallic material including a bonding portion, the bonding portion including a pattern formed by a laser; and a second metallic material bonded to the bonding portion of the first metallic material by die casting, wherein a portion of the second metallic material forming contact with the bonding portion of the first metallic material forms a reverse negative of the pattern.

### CROSS-REFERENCE TO RELATED APPLICATION

This application claims the priority under 35 U.S.C. § 119(a) to Korean Patent Application Serial No. 10-2017-0117445, which was filed in the Korean Intellectual Property Office on Sep. 13, 2017, the entire content of which is hereby incorporated by reference.

### BACKGROUND

### 1. Field

Various embodiments relate to a dissimilar metal member made of different materials and a method of manufacturing the dissimilar metal member.

### 2. Description of the Related Art

With the development of electronic technology, various popular electronic devices have been developed. For example, portable electronic devices such as a smartphone, a notebook PC, a tablet PC, and a wearable device have become increasingly popular.

The outer parts of the portable electronic devices can be made of synthetic resin or metallic materials. The metallic materials can be manufactured by bonding dissimilar metals to each other. In order to bond the dissimilar metal members, a method of using chemical erosion or a method of applying electricity (electric grinding) is generally used.

### SUMMARY

Non-uniform etching is a problem that occurs with different metallic materials. Dissimilar metallic materials can be used for the outer parts of a portable electronic device. When, however, a method of chemical erosion or applying electricity (electric grinding) is used to bond the dissimilar metallic materials, the entire surface other than a bonding portion of the dissimilar metallic materials may be unexpectedly etched non-uniformly. This problem may cause defects in products (e.g., a poor dimension, poor bonding, and poor waterproofing) in the manufacturing process.

In various embodiments the bonding force and waterproofing between different metallic materials can be improved by bonding the different metallic materials by forming a pattern at the bonding portion of the metallic materials using a laser, and a method of manufacturing the dissimilar metal member.

A dissimilar metal member according to various embodiments, comprises a first metallic material including a bonding portion, the bonding portion including a pattern formed by a laser, and a second metallic material bonded to the bonding portion of the first metallic material by die casting, wherein a portion of the second metallic material forming contact with the bonding portion of the first metallic material forms a reverse negative of the pattern.

A method of manufacturing a dissimilar metal member according to various embodiments includes laser etching a pattern at a bonding portion of a first metallic material; and injecting molten metal into a mold causing the molten metal to flow to the pattern; and cooling the molten metal, thereby forming a second metallic material.

The dissimilar metal member according to various embodiments includes a bonding portion and including stainless steel (SUS); a pattern formed at the bonding portion by a laser, wherein the depth of the pattern is less than 500 μm; and a second metallic material formed by performing die casting that injects molten metal including aluminum (AL) after inserting the first metallic material into a mold so that the molten metal flows to the pattern and is bonded to the first metallic material, wherein a portion of the second metallic material forming contact with the bonding portion of the first metallic material forms a reverse negative of the pattern.

A method of manufacturing a dissimilar metal member, the method comprising forming a pattern including a lattice shape at the bonding portion of the first metallic material using a laser; injecting molten metal including aluminum (AL) into a mold so that the molten metal flows to the pattern including the lattice shape after inserting the first metallic material into a mold, thereby forming and bonding a second metallic material to the first metallic material; performing a CNC process on the first and second metallic materials; and performing surface processing on the first and second metallic materials.

According to various embodiments, by forming a pattern at a bonding portion of a dissimilar metal member using a laser and bonding the dissimilar metal member using the pattern, it is possible to improve bonding force and waterproofing of first and second metallic materials that are different materials. Further, surface processing can be performed on the dissimilar metal member in various ways (e.g., depositing, anodizing, and coating).

According to various embodiments, when first and second metallic materials that are different materials are bonded by die casting, productivity can be improved, which is an advantage of die casting, the processing time of a product can be reduced, and the costs of materials and the weight of a product can be decreased.

### BRIEF DESCRIPTION OF THE DRAWINGS

FIG. 1 is a block diagram showing a network environment including an electronic device according to various embodiments;

FIG. 2A, FIG. 2B, FIG. 2C, FIG. 2D, and FIG. 2E are views showing a process of manufacturing a dissimilar metal member according to various embodiments;

FIG. 3 is a perspective view showing a pattern formed by laser processing at a bonding portion of a first metallic material of a dissimilar metal member according to various embodiments;

FIG. 4 is a cross-sectional view taken along line A-A′ shown in FIG. 3;

FIG. 5 is an enlarged view of the part A of FIG. 4;

FIG. 6A, FIG. 6B, FIG. 6C, and FIG. 6D are enlarged perspective views showing various shapes of patterns according to various embodiments;

FIG. 7A, FIG. 7B, FIG. 7C, and FIG. 7D are views showing in detail a process of manufacturing a dissimilar metal member according to various embodiments; and

FIG. 8 is a flowchart showing a method of manufacturing a dissimilar metal member according to various embodiments.

### DETAILED DESCRIPTION

The electronic device according to various embodiments disclosed herein may be various types of devices. The electronic device may, for example, include at least one of a portable communication device (e.g., smartphone) a computer device, a portable multimedia device, a portable medical device, a camera, a wearable device, and a home appliance. The electronic device according to one embodiment is not limited to the above described devices.

The embodiments and the terms used therein are not intended to limit the technology disclosed herein to specific forms, and should be understood to include various modifications, equivalents, and/or alternatives to the corresponding embodiments. In describing the drawings, similar reference numerals may be used to designate similar constituent elements. A singular expression may include a plural expression unless they are definitely different in a context. The terms “A or B”, “one or more of A and/or B”, “A, B, or C”, or “one or more of A, B and/or C” may include all possible combinations of them. The expression “a first”, “a second”, “the first”, or “the second” used in various embodiments may modify various components regardless of the order and/or the importance but does not limit the corresponding components. When an element (e.g., first element) is referred to as being “(functionally or communicatively) connected,” or “directly coupled” to another element (second element), the element may be connected directly to the another element or connected to the another element through yet another element (e.g., third element).

The term “module” as used herein may include a unit consisting of hardware, software, or firmware, and may, for example, be used interchangeably with the term “logic”, “logical block”, “component”, “circuit”, or the like. The “module” may be an integrated component, or a minimum unit for performing one or more functions or a part thereof. For example, a module may be an Application-Specific Integrated Circuit (ASIC).

Various embodiments disclosed herein may be implemented by software (e.g., program 140) including an instruction stored in machine-readable storage media (e.g., internal memory 136 or external memory 138). The machine is a device that calls the stored instruction from the storage media and can operate according to the called instruction, and may include an electronic device (e.g., electronic device 101) according to the disclosed embodiments. The instruction, when executed by a processor (e.g., processor 120), may cause the processor to directly execute a function corresponding to the instruction or cause other elements to execute the function under the control of the processor. The instruction may include a code that is generated or executed by a compiler or interpreter. The machine-readable storage media may be provided in the form of non-transitory storage media. Here, the term “non-transitory” only means that the storage media is tangible without including a signal, irrespective of whether data is semi-permanently or transitorily stored in the storage media.

A method according to various embodiments disclosed herein may be included and provided in a computer program product. The computer program product may be traded between a seller and a purchaser as an item. The computer program product may be distributed in the type of a device-readable storage medium (e.g., a Compact Disc Read Only Memory (CD-ROM) or through an application store (e.g., play store™) on the web. When the computer program product is distributed on the web, at least a portion of the computer program product may be at least temporarily stored or created in a storage medium such as the memory of the server of the manufacturer, the server of an application store, or a relay server.

Components (e.g., a module or a program) according to various embodiments may be single units or may be composed of various elements, and some of corresponding sub-components may be omitted or other sub-components may be further included in various embodiments. Generally or additionally, some components (e.g., a module or a program) may be integrated in a single unit and perform similarly or in the same way the functions of the components before they are integrated. Operations that are performed by modules, programs, or other components according to various embodiments may be performed sequentially, in parallel, repeatedly, or heuristically, or at least some operation may be performed in another order or omitted, or other operations may be added.

Certain embodiments can house an electronic device.

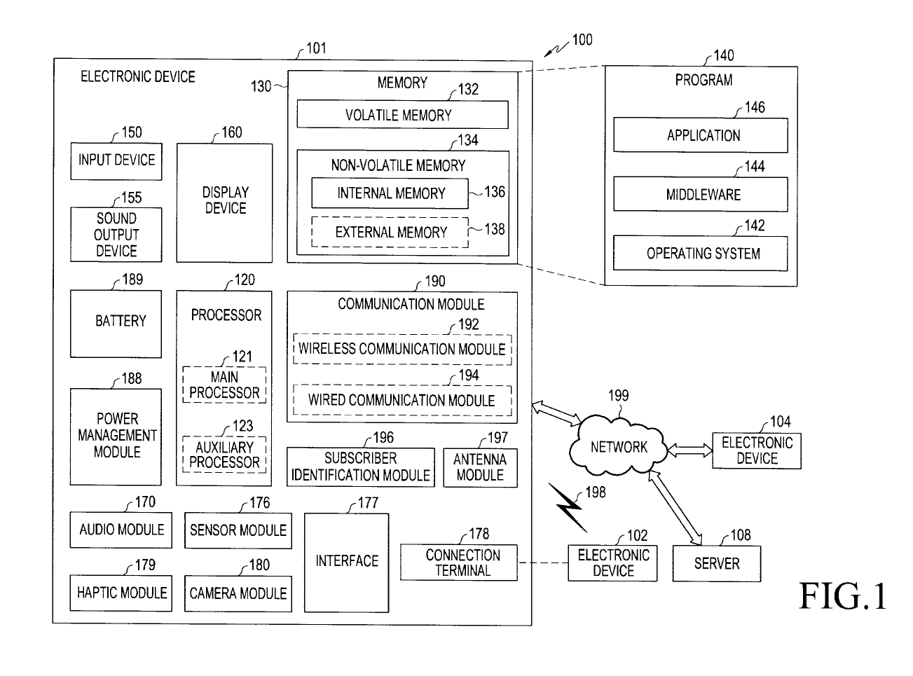

FIG. 1 is a block diagram of an electronic device 101 that can housed in a housing in accordance with various embodiments, the electronic device 101 in a network environment 100. Referring to FIG. 1, the electronic device 101 in the network environment 100 can communicate with an electronic device 102 through a first network (e.g. near field communication) or can communicate with an electronic device 104 or a server 108 through a second network 199 (e.g., long distance wireless communication). According to an embodiment, the electronic device 101 can communicate with the electronic device 104 through the server 108. According to an embodiment, the electronic device 101 may include a processor 120, a memory 130, an input device 150, a sound output device 155, a display device 160, an audio module 170, a sensor module 176, an interface 177, a haptic module 179, a camera module 180, an power management module 188, a battery 189, a communication module 190, a subscriber identifier module 196, and an antenna module 197. In an embodiment, in the electronic device 101, at least one (e.g., the display device 160 or the camera module 180) of the components may be removed or another component may be added. In an embodiment, for example, some components may be integrated such as the sensor module 176 (e.g., a fingerprint sensor, an iris sensor, or an illumination sensor) embedded in the display device 160 (e.g., a display).

The processor 120, for example, can control at least one component (e.g., a hardware or software component) connected to the processor 120 of the electronic device 101 by executing software (e.g., a program 140) and can process and calculate various data. The processor 120 can load and process commands or data received from another component (e.g., the sensor module 176 or the communication module 190) in a volatile memory 132, and can store the resultant data in a nonvolatile memory 134. According to an embodiment, the processor 120 may include a main processor 121 (e.g., a central processing unit or an application processor) and a coprocessor 123 (e.g., a graphic processor, an image signal processor, a sensor hub processor, or a communication processor) that is operated independently from the main processor and, additionally or alternatively, uses less power than the main processor 121 or is specified for predetermined functions. The coprocessor 123 may be operated separately from the main processor 121 or may be embedded and operated.

In this case, the coprocessor 123 can control at least some of the functions or states related to at least one (e.g., the display device 160, the sensor module 176, or the communication module 190) of the components of the electronic device 101, for example, instead of the main processor 121 when the main processor 121 is in an inactive (e.g., sleep) state or together with the main processor 121 when the main processor 121 is in an active state (e.g., in operation for executing an application). According to an embodiment, the coprocessor 123 (e.g., an image signal processor or a communication processor) may be implemented as a partial component of another functionally related component (e.g., the camera module 180 or the communication module 190). The memory 130 can store various data, for example, software (e.g., the program 140) that is used by at least one component (e.g., the processor 120 or the sensor module 176) of the electronic device 101, and can input data or output data for commands related to the software. The memory 130 may include a volatile memory 132 and/or a nonvolatile memory 134.

The program 140, which is software stored in the memory 130, for example, may include an operating system 142, middleware 144, or an application 146.

The input device 150, which is a device for receiving commands or data to be used by components (e.g., the processor 120) of the electronic device 101 from the outside (e.g., a user) of the electronic device 101, may include, for example, a microphone, a mouse, or a keyboard.

The sound output device 155, which is a device for outputting sound signals to the outside of the electronic device 101, for example, may include a speaker that is used for common purposes such as playing of multimedia or recorded sounds, and a receiver that is used only for receiving a telephone call. According to an embodiment, the receiver may be formed integrally with or separately from the speaker.

The display device 160, which is a device for visually showing information to a user of the electronic device 101, for example, may include a display, a hologram device, or a projector and a control circuit for controlling the corresponding device. According to an embodiment, the display device 160 may include touch circuitry or a pressure sensor that can measure the intensity of pressure by a touch.

The audio module 170, for example, can bidirectionally convert sound and an electrical signal. According to an embodiment, the audio module 170 can acquire a sound through the input device 150 or can output a sound through the sound output device 155 or an external electronic device (e.g., the electronic device 102 (e.g., a speaker or a headphone) connected to the electronic device 101 through a wire or wirelessly.

The sensor module 176 can generate an electrical signal or a data value corresponding to the operation state (e.g., power or temperature) in the electronic device 101 or an external environmental state. The sensor module 176, for example, may include a gesture sensor, a gyro sensor, a barometer sensor, a magnetic sensor, an acceleration sensor, a grip sensor, a proximity sensor, a color sensor, an IR (Infrared) sensor, a biosensor, a temperature sensor, a humidity sensor, or an illumination sensor.

The interface 177 can support a predetermined protocol that allows for connection to an external electronic device (e.g., the electronic device 102) through a wire or wirelessly. According to an embodiment, the interface 177 may include a High Definition Multimedia Interface (HDMI), a Universal Serial Bus (USB) interface, an SD card interface, or an audio interface.

A connection terminal 178 may include a connector that can physically connect the electronic device 101 with an external electronic device (e.g., the electronic device 102), such as an HDMI connector, a USB connector, an SD card connector, or an audio connector (e.g., a headphone connector).

The haptic module 179 can convert an electrical signal into a mechanical stimulus (e.g. vibration or movement) or an electrical stimulus that a user can recognize through the sensor touch or the sensation of movement. The haptic module 179, for example, may include a motor, a piezoelectric device, or an electric stimulator.

The camera module 180 can take still images and moving images. According to an embodiment, the camera module 180 may include one or more lenses, an image sensor, an image signal processor, or a flash.

The power management module 188, which is a module for managing the power that is supplied to the electronic device 101, for example, may be at least a part of a Power Management Integrated Circuit (PMIC).

The battery 189, which is a device for supplying power to one or more components of the electronic device 101, for example, may include a primary battery that is not rechargeable, a secondary battery that is rechargeable, or a fuel cell.

The communication module 190 can establish a wired or wireless communication channel between the electronic device 101 and an external electronic device (e.g., the electronic device 102, the electronic device 104, or the server 108), and can support communication through the established communication channel. The communication module 190 may include one or more communication processors that support wired communication or wireless communication that is operated independently from the processor 120 (e.g., an application processor). According to an embodiment, the communication module 190 may include a wireless communication module 192 (e.g., a cellular communication module, a near field communication module, or a Global Navigation Satellite System (GNSS) communication module) or a wired communication module 194 (e.g., a Local Area Network (LAN) communication module or a power line communication module). Further, the communication module 190 can communicate with an external electronic device through the first network 198 (e.g., a LAN such as Bluetooth, Wi-Fi direct or Infrared Data Association (IrDA)) or through the second network 199 (e.g., a wide area network such as a cellular network, the internet, or a computer network (e.g., a LAN or a WAN), using the corresponding communication module. The various communication modules 190 described above may be implemented in one chip or separate chips.

According to an embodiment, the wireless communication module 192 can identify and authenticate the electronic device 101 in a communication network, using user information stored in the subscriber identifier module 196.

The antenna module 197 may include one or more antennas for transmitting or receiving signals or power to or from the outside. According to an embodiment, the communication module 190 (e.g., the wireless communication module 192) can transmit or receive signals to or from an external electronic device through an antenna suitable for the communication method.

Some of the components can be connected to each other and exchange signals (e.g., commands or data) with each other through communication methods among peripheral devices (e.g., a bus, a General Purpose Input/Output (GPIO), a Serial Peripheral Interface (SPI), or a Mobile Industry Processor Interface (MIPI).

According to an embodiment, commands or data can be transmitted or received between the electronic device 101 and the external electronic device 104 through the server 108 connected to the second network 199. The electronic devices 102 and 104 may be the same kind of device as the electronic device 101, or may be different therefrom. According to an embodiment, all or some of the operations of the electronic device 101 may be performed by another one or a plurality of external electronic devices. According to an embodiment, when the electronic device 101 has to perform a function or service automatically or due to a request, the electronic device 101 may request at least partial function related to the function or service from an external electronic device additionally or instead of performing the function or service by itself. The external electronic device receiving the request can perform the requested function or an additional function and transmit the result to the electronic device 101. The electronic device 101 can provide the requested function or service on the basis of the received result or by additionally processing the received result. To this end, for example, cloud computing, distributed computing, or client-server computing may be used.

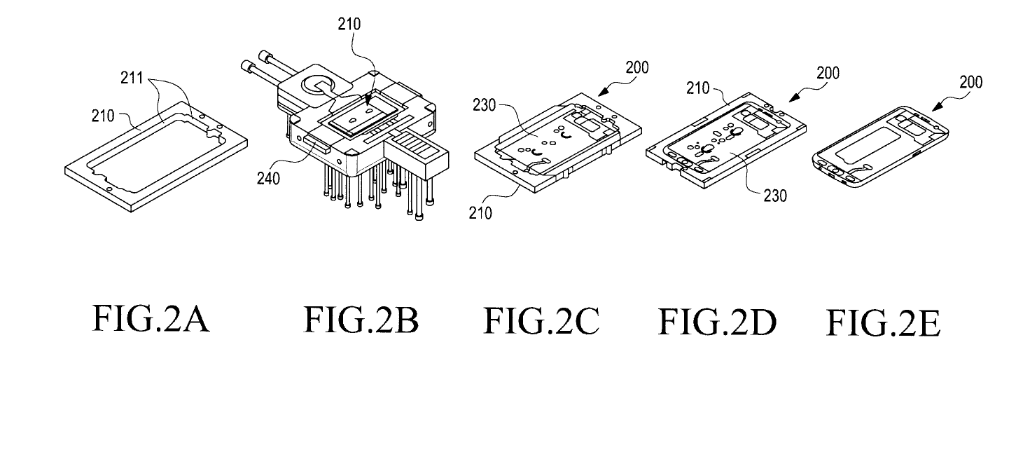

Dissimilar metal members (e.g., 200 in FIG. 2E) included in the electronic devices are made synthetic resin or metallic materials and can be manufactured in predetermined shapes by injection molding for synthetic resin and by die casting for metallic materials. A metallic member is formed in a predetermined shape in a mold by injecting molten resin into the mold in injection molding and by injecting molten metal into the mold in die casting. A forming method that uses injection molding or die casting can be used to form not only the outer parts of electronic devices, but also home appliances and precise machine parts.

FIGS. 2A, 2B, 2C, 2D, and 2E are views showing a process of manufacturing a dissimilar metal member 200 according to various embodiments.

First, referring to FIG. 2A, a first metallic material 210 having a bonding portion 211 may be manufactured. The first metallic material 210 may be formed in a frame shape with an internal space by machining. The bonding portion 211 may be formed in the inner side of the frame.

The first metallic material 210 may include at least one of aluminum (AL), stainless steel (SUS), titanium (TiTan), ceramic, and amorphous metal. Although aluminum (AL), stainless steel (SUS), titanium (TiTan), ceramic, and amorphous metal are described in this embodiment, the first metallic material 210 is not limited thereto. That is, various metallic materials can be used for the first metallic material 210 as long as they have the bonding portion 211 to which molten metal is bonded.

In various embodiments, the first metallic material 210 stainless steel SUS.

The amorphous metal may include alloys of precious metals (Au, Ag) with transition metals (Ni, Co, Fe, Pd), semimetals (Ge, Si), or nonmetals (P, C, B).

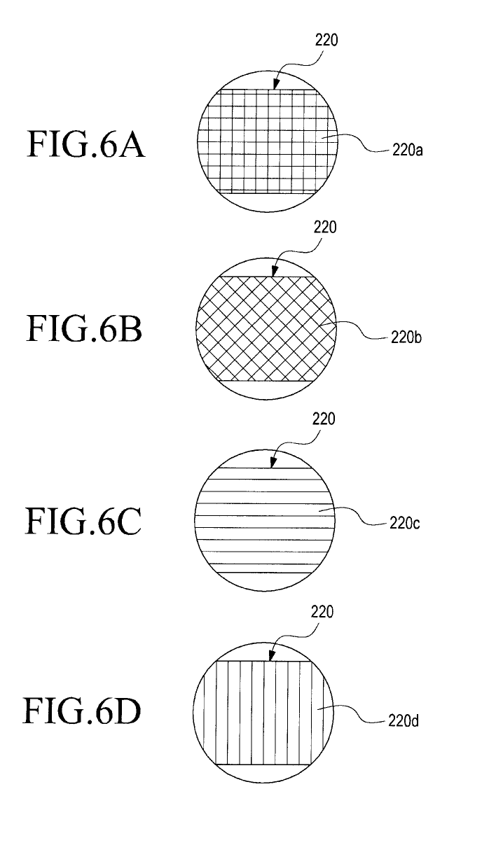

A pattern 220 may be formed at the bonding portion 211 of the first metallic material 210 by laser processing. The patterns 220 are described in FIG. 6 and can include, but is not limited to a lattice shape, diamond shape, horizontal lines, and vertical lines.

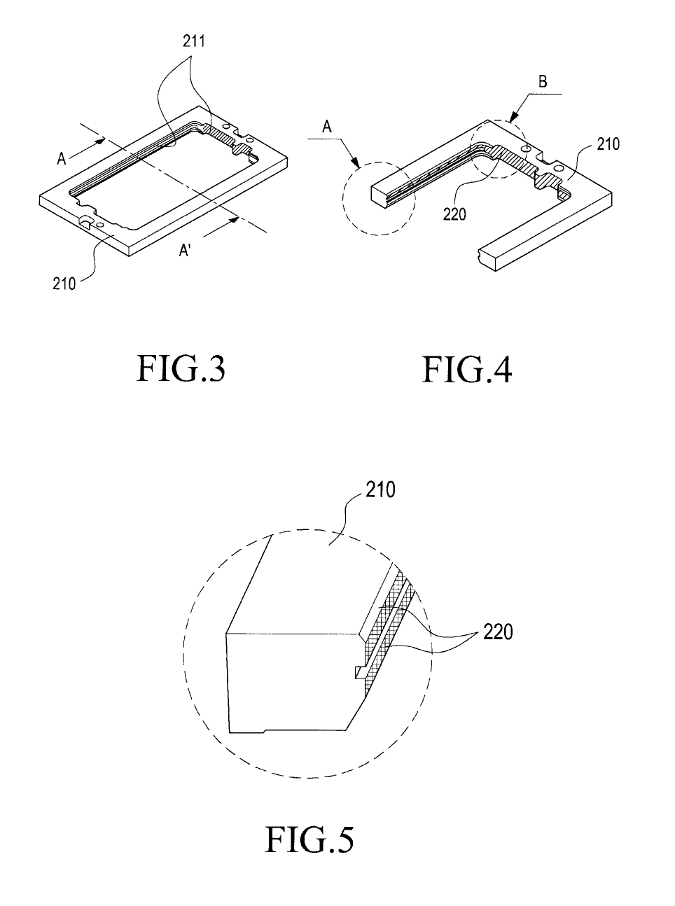

FIG. 3 is a perspective view showing the pattern 220 formed by a laser at the bonding portion 221 of the first metallic material 210 of the dissimilar metal member 200 according to various embodiments and FIG. 4 is a cross-sectional view taken along line A-A′ shown in FIG. 3.

Referring to FIGS. 3 and 4, a bonding portion 211 may be formed on the inner side of the first metallic material 210 and the pattern 220 can be formed at the bonding portion 211 with a laser. The pattern 220 may be formed on a surface that bonds to molten metal. According to an embodiment, the pattern 220 may be formed on a surface that bonds to synthetic resin. For example, the synthetic resin may be molten resin. For example, molten metal or molten resin may be bonded to the pattern 220.

FIG. 5 is an enlarged perspective view of the pattern 220 formed at the bonding portion 211 of the first metallic material 210.

As shown in FIG. 5, the pattern 220 may be formed on the surface of the bonding portion 211 that bonds to the first metallic material 210. For example, the pattern 220 may be formed by etching the surface of the bonding portion 211 using a laser. The pattern 220 may also have a line groove etched by a laser. Molten material can be inserted and bonded in the line groove in die casting.

FIGS. 6A, 6B, 6C, and 6D are enlarged perspective views of the part B of FIG. 4 and show various shapes of the pattern 220 according to various embodiments.

The pattern 220 may have a lattice shape 220a in FIG. 6A, a diamond shape 220b in FIG. 6B, a repeated horizontal-line shape 220c in FIG. 6C, and a repeated vertical-line shape 220d in FIG. 6D.

The shape of the pattern 220 may include at least one of the lattice shape 220a, the diamond shape 220b, the repeated horizontal-line shape 220c, and the repeated vertical-line shape 220d. The pattern 220 may have various shapes other than the shapes described above.

The laser may be operated by power between 20 W to 100 W to form the pattern on the bonding portion. For example, when power of 20 W is supplied to the laser to form a pattern, the depth of the pattern may be in the range of 100 μm˜400 μm, or in certain embodiments, less than 500 μm, the pitch of the pattern may include 100 μm˜150 μm, and the pattern may be processed five to seven times. The bonding strength of the pattern may be in the range of 130.4 MPa 169.5 MPa.

For purposes of discussion, hereafter the pattern 220 according to various embodiments has the lattice shape 220a.

For example, when a laser with 20 W power forms the pattern 220 having the lattice shape 220a, the depth of the pattern may be 400 μm, the pitch of the pattern may be 110 μm, and the pattern may be processed five times.

As shown in FIG. 2B stated above, the pattern 220 having the lattice shape on the bonding portion 211 of the first metallic material 210 is formed. The mold 240 receives the first metallic material 210 having the pattern 220. Die casting can be performed by injecting molten metal into the mold 240. The molten metal injected into the mold 240 is inserted into the pattern 220 having the lattice shape of the first metallic material 210. When the molten metal cools, a second metallic material 230 is be bonded to the first metallic material 210 at the lattice pattern 220a. In certain embodiments, the second metallic material 230 can form an exact reverse negative of the pattern 220. Thus, the second metallic material 230 enters the cavity of a pattern, even with a depth as little as 400 μm. The portions of the second metallic material 230 that enter the pattern form protrusions forming lateral that can hold the second metallic material 230 in place.

For example, by cooling molten metal injected in the mold 240 during die casting, the molten metal injected in the mold 240 and the pattern 220 having the lattice shape of the first metallic material 210 physically bond, thereby forming the second metallic material 230. The bonding strength of the first and second metallic materials 210 and 230 may achieve 169.5 MPa.

The second metallic material 230 may include, but is not limited to, at least one of aluminum AL and magnesium MG. That is, various metallic materials can be used for the second metallic material as long as they can be bonded to the first metallic material 210.

For purposes of discussion, the second metallic material 230 that includes aluminum AL will be described in various embodiments.

As shown in FIG. 2C stated above, it is possible to finish bonding the first metallic material 210 and the second metallic material 230 after die casting.

Next, as shown in FIG. 2D, a Computerized Numerical Control (CNC) process can be performed on the first and second metallic materials 210 and 230 that have been bonded. For example, the first metallic material 210 and second metallic material 230 can be formed in a frame shape for the external part of an electronic device (e.g., 101 in FIG. 1) by a CNC process, and then tap holes for mounting a display, a battery, and fasteners in the electronic device (e.g., 101 in FIG. 1) can be formed.

As shown in FIG. 2E, surface processing can be performed on the first and second metallic materials 210 and 230 after a CNC process. The surface processing of the first and second metallic materials 210 and 230 may be performed by at least one of depositing, anodizing, and coating.

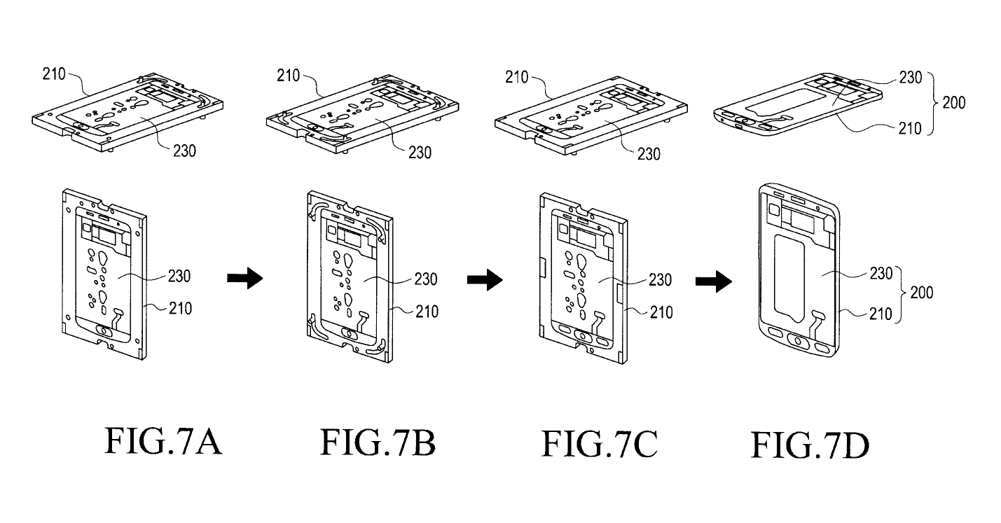

FIGS. 7A, 7B, 7C, and 7D are views showing in detail a process of manufacturing the dissimilar metal member 200 according to various embodiments.

As shown in FIG. 7A, a first CNC process may be performed on the first and second metallic materials 210 and 230 bonded after die casting. Next, as shown in FIG. 7B, a nonmetallic material may be applied to the first and second metallic materials 210 and 230 by insert injection molding after the first CNC process. For example, the nonmetallic material may include plastic resin. Holes formed after the first CNC process may be filled with the nonmetallic material in insert injection molding or one or more protrusions may be formed on the first and second metallic materials 210 and 230. The protrusions can be coupled and fixed to parts of an electronic device (e.g., 101 in FIG. 1).

As shown in FIG. 7C, a second CNC process can be performed on the first and second metallic materials 210 and 230 and the first and second metallic materials 210 and 230 that have undergone the second CNC process can be manufactured into a dissimilar metal member 200 that is used for an electronic device (e.g., 101 in FIG. 1), as shown in FIG. 7D.

As described above, it is possible to form the pattern 220 having a lattice shape on the bonding portion 221 of the first metallic material 210, using a laser. Further, it is possible to physically bond the second metallic material 230 to the bonding portion 211 of the first metallic material 210 inserted in the mold 240 through die casting. The bonding strength of the first and second metallic materials 210 and 230 can be significantly increased in this case. Accordingly, the bonding force and waterproof ability of the first and second metallic materials 210 and 230 can be improved.

According to an embodiment, it is possible to not only reduce the manufacturing time of a product, but reduce the costs of materials and the weight of the product by bonding the first metallic material 210 including stainless steel SUS and the second metallic material including aluminum AL to each other.

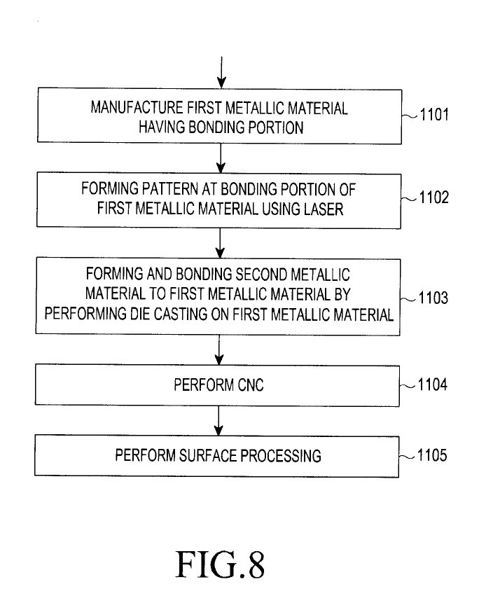

FIG. 8 is a flowchart showing a method of manufacturing a dissimilar metal member according to various embodiments.

Referring to FIG. 8, a first metallic material 210 made of stainless steel SUS and having a bonding portion 211 may be manufactured first (1101).

Next, a pattern 220 may be formed at the bonding portion 211 of the first metallic material 210 by laser processing. The pattern 220 may have a lattice shape (1102).

Die casting that inject molten material of aluminum AL may be performed after the first metallic material 210 is inserted in a mold 240 and then the molten metal is injected to the pattern 220 of the lattice shape 220a, whereby it is possible to form and bond a second metallic material 230 to the first metallic material 210 (1103).

For example, when the pattern 220 having the lattice shape 220a is formed by supplying power of 20 W to a laser, the depth of the pattern 220 may be 400 μm, the pitch of the pattern 220 having the lattice shape 220a may be 110 μm, the pattern 220 having the lattice shape 220a may be processed five times. When the first and second metallic materials 210 and 230 are bonded after die casting, the bonding strength of the first and second metallic materials 210 and 230 may be maximum 169.5 MPa.

A CNC process may be performed on the first and second metallic materials 210 and 230 (1104). According to the CNC process, a first CNC process may be performed on the first and second metallic materials 210 and 230 bonded after die casting and a nonmetallic material may be applied to the first and second metallic materials 210 and 230 by insert injection molding after die casting. A second CNC process may be performed on the first and second metallic materials 210 and 230 after the nonmetallic material is applied to the first and second metallic materials 210 and 230 by insert injection molding. Surface processing may be performed on the first and second metallic materials 210 and 230 after the second CNC process (1105).

The pattern 220 is formed at the bonding portion 211 of the first metallic material 210 by a laser, the first metallic material 210 is inserted into the mold 240, and the molten metal is injected, whereby the molten metal can flow to the pattern 220 and form the second metallic material 230 when flowing into the mold 240. As the molten metal hardens, the first and second metallic materials 210 and 230 are completely physically bonded, whereby the dissimilar metal member 200 can be manufactured. The inside of the dissimilar metal member 200 may be made of the second metallic material 230 including aluminum (AL) and the outer part of the dissimilar metal member may be made of the first metallic material 210 including stainless steel (SUS).

The surface processing of the first and second metallic materials 210 and 230 may include one of depositing, anodizing, and coating.

Table 1 shows the bonding strength (MPa) of the pattern 220 formed at the bonding portion 211 of the first metallic material 210.

Referring to Table 1, it can be seen that the bonding strength of the dissimilar metal member formed by bonding the first metallic material 210 including stainless steel SUS and the second metallic material 230 including aluminum AL is 144.4 Mpa, which is the maximum bonding strength, when the pattern 220 is formed in a lattice shape (e.g., 220a in FIG. 6A). Further, it can be seen that it takes two minutes or less to form the pattern 220 including the lattice shape (e.g., 220a in FIG. 6A).

Accordingly, as the pattern 220 is formed in a lattice shape (e.g., 220a in FIG. 6A) at the bonding portion 211 of the dissimilar metal member 200 formed by bonding the first metallic material 210 including stainless steel SUS and the second metallic material 230 including aluminum AL, it is possible to improve productivity, reduce the processing time of the product, and decrease the costs of materials and the weight of the product.

According to various embodiments, a dissimilar metal member may includes: a first metallic material including a bonding portion; a pattern formed at the bonding portion by a laser; and a second metallic material formed by performing die casting that injects molten metal after inserting the first metallic material into a mold so that the molten metal flows to the pattern and is bonded to the first metallic material.

According to various embodiments, the first metallic material may include at least one of aluminum (AL), stainless steel (SUS), titanium (TiTan), ceramic, and amorphous metal.

According to various embodiments, the shape of the pattern may include at least one of a lattice shape, a diamond shape, a repeated vertical-line shape, and a repeated horizontal-line shape.

According to various embodiments, the second metallic material may include at least one of aluminum AL and magnesium MG.

According to various embodiments, a first CNC process may be performed on the first and second metallic materials after die casting, a nonmetallic material may be applied to the first and second metallic materials by insert injection molding after the first CNC process, a second CNC process may be performed after the nonmetallic material is applied to the first and second metallic materials by insert injection molding, and surface processing may be performed on the first and second metallic materials after the second CNC process.

According to various embodiments, the surface processing of the first and second metallic materials may be performed by at least one of depositing, anodizing, and coating.

According to various embodiments, a method of manufacturing a dissimilar metal member may include: manufacturing a first metallic material including a bonding portion; forming a pattern at the bonding portion of the first metallic material using a laser; forming and bonding a second metallic material to the first metallic material by performing die casting that injects molten metal so that the molten metal flows to the pattern after inserting the first metallic material into a mold; performing a CNC process on the first and second metallic materials; and performing surface processing on the first and second metallic materials.

According to various embodiments, a dissimilar metal member may includes: a first metallic material including a bonding portion and including stainless steel (SUS); a pattern formed at the bonding portion by a laser; and a second metallic material formed by performing die casting that injects molten metal including aluminum (AL) after inserting the first metallic material into a mold so that the molten metal flows to the pattern and is bonded to the first metallic material.

According to various embodiments, a method of manufacturing a dissimilar metal member may include: manufacturing a first metallic material including a bonding portion and including stainless steel (SUS); forming a pattern including a lattice shape at the bonding portion of the first metallic material using a laser; forming and bonding a second metallic material to the first metallic material by performing die casting that injects molten metal including aluminum (AL) so that the molten metal flows to the pattern including the lattice shape after inserting the first metallic material into a mold; performing a CNC process on the first and second metallic materials; and performing surface processing on the first and second metallic materials.

The dissimilar metal member and methods of manufacturing the same according to the present disclosure are not limited to the above-described embodiments and the drawings, but it will be appreciated by those skilled in the art to which the present disclosure pertains that the present disclosure can be variously replaced, modified, and changed without departing from the spirit of the present disclosure.

What is claimed is:

1. A dissimilar metal member comprising:
a first metallic material including a bonding portion, the bonding portion including a pattern formed by a laser; and
a second metallic material bonded to the bonding portion of the first metallic material by die casting, wherein a portion of the second metallic material forming contact with the bonding portion of the first metallic material forms a reverse negative of the pattern.

2. The dissimilar metal member of claim 1, wherein the first metallic material includes at least one of aluminum (AL), stainless steel (SUS), titanium (TiTan), ceramic, and amorphous metal.

3. The dissimilar metal member of claim 1, wherein a shape of the pattern includes at least one of a lattice shape, a diamond shape, a repeated vertical-line shape, and a repeated horizontal-line shape.

4. The dissimilar metal member of claim 1, wherein the second metallic material may include at least one of aluminum AL and magnesium MG.

5. The dissimilar metal member of claim 1, wherein first a Computerized Numerical Control (CNC) process is performed on the first and second metallic materials after die casting, a nonmetallic material is applied to the first and second metallic materials by insert injection molding after the first CNC process, a second CNC process is performed after the nonmetallic material is applied to the first and second metallic materials by insert injection molding, and surface processing is performed on the first and second metallic materials after the second CNC process.

6. The dissimilar metal member of claim 1, wherein the first and second metallic materials have surfaces that are surface processed by at least one of depositing, anodizing, and coating.

7. The dissimilar metal member of claim 1, wherein a second metallic material is formed and bonded to the first metallic material by performing die casting that injects molten metal so that the molten metal flows to the pattern after the first metallic material is inserted into a mold.

8. A method of manufacturing a dissimilar metal member, the method comprising:
laser etching a pattern at a bonding portion of a first metallic material;
injecting molten metal into a mold causing the molten metal to flow to the pattern; and
cooling the molten metal, thereby forming a second metallic material.

9. The method of claim 8, wherein the first metallic material includes at least one of aluminum (AL), stainless steel (SUS), titanium (TiTan), ceramic, and amorphous metal.

10. The method of claim 8, wherein a shape of the pattern includes at least one of a lattice shape, a diamond shape, a repeated vertical-line shape, and a repeated horizontal-line shape.

11. The method of claim 8, wherein the second metallic material may include at least one of aluminum AL and magnesium MG.

12. The method of claim 8, further comprising:
performing a Computerized Numerical Control (CNC) process on the first and second metallic materials bonded after cooling the molten metal,
injecting a nonmetallic material, causing the nonmetallic material to apply to the first and second metallic materials after the first CNC process,
performing a second CNC process after the nonmetallic material is applied to the first and second metallic materials, and
processing a surface on the first and second metallic materials after the second CNC process.

13. The method of claim 8, wherein the surface processing of the first and second metallic materials comprises at least one of depositing, anodizing, and coating.

14. A dissimilar metal member comprising:
a first metallic material including a bonding portion and including stainless steel (SUS);
a pattern formed at the bonding portion by a laser, wherein a depth of the pattern is less than 500 μm; and
a second metallic material formed by performing die casting that injects molten metal including aluminum (AL) after inserting the first metallic material into a mold so that the molten metal flows to the pattern and is bonded to the first metallic material, wherein a portion of the second metallic material forming contact with the bonding portion of the first metallic material forms a reverse negative of the pattern.

15. The dissimilar metal member of claim 14, wherein a shape of the pattern includes a lattice shape.

16. A method of manufacturing a dissimilar metal member, the method comprising:
forming a pattern including a lattice shape at the bonding portion of a first metallic material using a laser;
injecting molten metal including aluminum (AL) into a mold so that the molten metal flows to the pattern including the lattice shape after inserting the first metallic material into a mold, thereby forming and bonding a second metallic material to the first metallic material;
performing a CNC process on the first and second metallic materials; and
performing surface processing on the first and second metallic materials.

17. The method of claim 16, wherein performing of the CNC process on the first and second metallic materials comprises:
performing a first CNC process on the first and second metallic materials bonded after die casting,
insert injecting a nonmetallic material into another mold, thereby applying the nonmetallic material to the first and second metallic materials after the first CNC process,
performing a second CNC process after the nonmetallic material is applied to the first and second metallic materials, and
processing the surface of the first and second metallic materials after the second CNC process.
